(19) United States
(12) Patent Application Publication
(10) Pub. No.: US 2026/0138414 A1
(43) Pub. Date: May 21, 2026

(54) THERMAL MANAGEMENT SYSTEM FOR A HYBRID OR ELECTRIC VEHICLE

(71) Applicant: VALEO SYSTEMES THERMIQUES, Le Mesnil-Saint-Denis (FR)

(72) Inventors: Rody El-Chammas, Le Mesnil-Saint-Denis (FR); Muriel Porto, Le Mesnil-Saint-Denis (FR); Bertrand Nicolas, Le Mesnil-Saint-Denis (FR); Samy Hammi, Le Mesnil-Saint-Denis (FR); Franck Truillet, Le Mesnil-Saint-Denis (FR)

(73) Assignee: VALEO SYSTEMES THERMIQUES, Le Mesnil-Saint-Denis (FR)

(21) Appl. No.: 19/120,556

(22) PCT Filed: Oct. 12, 2023
(86) PCT No.: PCT/EP2023/078294

§ 371 Date: Apr. 11, 2025

(30) Foreign Application Priority Data
Oct. 12, 2022 (FR) FR2210503

(51) Int. Cl. B60H 1/00; B60H 1/14; B60K 11/04

(52) U.S. Cl. CPC B60H 1/00385; B60H 1/00278; B60H 1/00907; B60H 1/143; B60K 11/04; B60H 2001/00307; B60H 2001/00928

(57) ABSTRACT

A thermal management system for a hybrid or electric vehicle includes a reversible air conditioning circuit in which a refrigerant circulates; and a two-fluid heat exchanger arranged jointly on a circuit for the first heat transfer fluid. The circuit for the first heat transfer fluid is configured such that, in a first loop for the first heat transfer fluid, the first heat transfer fluid passes through the heating device, passes through the two-fluid heat exchanger and enters the first pump. The heating device and the two-fluid heat exchanger are active, so at a same time as or independently of the circulation of the first heat transfer fluid in the first loop for the first heat transfer fluid, the circuit is configured such that, in a second loop for the first heat transfer fluid, the first heat transfer fluid entering a “batteries” heat exchanger passes through an “electric machines” heat exchanger.

### TECHNICAL FIELD OF THE INVENTION

The invention relates to the field of motor vehicles and more particularly to a thermal management circuit for a hybrid or electric motor vehicle.

### TECHNICAL BACKGROUND

In electric and hybrid vehicles, the thermal management of the vehicle interior is generally performed by a reversible air conditioning circuit. Reversible is given to mean that this air conditioning circuit can operate in a cooling mode in order to cool the air sent to the vehicle interior and in a heat pump mode in order to heat the air sent to the vehicle interior. This reversible air conditioning circuit can also include a spur in order to manage the temperature of the batteries of the electric or hybrid vehicle. It is thus possible to cool or even to heat the batteries using the reversible air conditioning loop. In heat pump mode, heat energy is taken from the outside air and transmitted to an internal air flow which is blown into the vehicle interior to heat the latter.

However, when the outside temperature is very low, it is not possible to use the air conditioning circuit in this heat pump mode.

It is therefore known practice to arrange in the internal air flow an electric heating device which directly heats the air flow. However, this requires that an additional component be arranged in the air flow, and this is expensive and takes up space in the vehicle.

One of the aims of the present invention is therefore to overcome at least some of the drawbacks of the prior art and propose an improved thermal management circuit.

### SUMMARY OF THE INVENTION

One aspect of the invention relates to a thermal management system for a hybrid or electric vehicle, the thermal management system comprising a reversible air conditioning circuit in which a refrigerant circulates and comprising a two-fluid heat exchanger arranged jointly on a circuit for a first heat transfer fluid, the air conditioning circuit comprising the following in succession, in a main loop: a compressor, a first heat exchanger arranged to exchange heat energy with a heat transfer fluid directly or indirectly, the heat transfer fluid being for example an internal air flow blown into the vehicle interior, an expansion member for the refrigerant and a second heat exchanger arranged to exchange heat energy with a heat transfer fluid directly or indirectly, the heat transfer fluid being for example an internal air flow blown into the vehicle interior,
the circuit for the first heat transfer fluid comprising:
   a first branch comprising a first pump, a heating device for the first heat transfer fluid, and the two-fluid heat exchanger,
   a second branch, an upstream end of which is connected directly to the first branch downstream of the two-fluid heat exchanger and a downstream end of which is connected directly to an upstream end of the first branch,
wherein the circuit for the first heat transfer fluid comprises:
   a third branch which comprises a second pump and a third heat exchanger, for example an “electric machines” heat exchanger which allows the exchange of heat between the power electronics and/or an electric motor of the vehicle, for the one part, and the first heat transfer fluid, for the other part,
   a fourth branch which comprises a fourth heat exchanger, for example a “batteries” heat exchanger, which is configured to make it possible to exchange heat between batteries of the vehicle and the first heat transfer fluid, the fourth branch comprising an upstream end which is connected to a downstream end of the first branch and a downstream end which is connected to the second branch, an upstream end of the fourth branch being connected to a downstream end of the third branch, and a downstream end of the fourth branch being connected to an upstream end of the third branch,
   the circuit for the first heat transfer fluid being configured such that, in a first mode of heating the internal air flow:
      in a first loop for the first heat transfer fluid, the first heat transfer fluid passing through the heating device, for example all of the fluid passing through the heating device, passes through the two-fluid heat exchanger and enters the first pump, the heating device and the two-fluid heat exchanger being active, in particular so as to heat the refrigerant entering the two-fluid heat exchanger,
      and, at the same time as or independently of the circulation of the first heat transfer fluid in the first loop for the first heat transfer fluid, the circuit is configured such that, in a second loop for the first heat transfer fluid, the first heat transfer fluid entering the “batteries” heat exchanger, for example all of the first heat transfer fluid entering the “batteries” heat exchanger, passes through the “electric machines” heat exchanger and enters the second pump, in particular so as to heat the first heat transfer fluid passing through the “batteries” heat exchanger using the heat recovered by the “electric machines” heat exchanger.

To this end, the system comprises a central control unit, this unit comprising at least a computer, a memory and a computer program stored in the memory, the computer program being configured to cause the system to operate in the way described above and below.

This system makes it possible to perform at least two functions with a single circuit for a first heat transfer fluid, these functions being to heat the batteries via the electric motor and also to recover heat from the electrical heating device and send it to the vehicle interior.

According to certain aspects of the invention, the above system comprises one or more of the following features, considered alone or in any technically possible combination:
in the first branch, the two-fluid heat exchanger is arranged downstream, preferably directly downstream, of the heating device for the first heat transfer fluid;
apart from the first pump, the heating device for the first heat transfer fluid, and the two-fluid heat exchanger, the first branch does not include any other device capable of substantially modifying the amount of heat accumulated by the first heat transfer fluid;
the second branch does not include any device capable of substantially modifying the amount of heat accumulated by the first heat transfer fluid;
the circuit for the first heat transfer fluid is configured to be able to make all of the refrigerant passing through the heating device and the two-fluid heat exchanger circulate through the “batteries” heat exchanger in a third loop for first heat transfer fluid, in particular so as to heat the first heat transfer fluid passing through the “batteries” heat exchanger when the heating device is active or alternatively so as to cool the first heat transfer fluid passing through the “batteries” heat exchanger when the two-fluid heat exchanger is active;
the circuit for the first heat transfer fluid comprises a first three-way valve connecting the first branch downstream of the two-fluid heat exchanger, the fourth branch upstream of the “batteries” heat exchanger, and the upstream end of the second branch;
the circuit for the first heat transfer fluid comprises a fifth branch provided with a radiator arranged in an external air flow, a downstream end of the fifth branch being connected to an upstream end of the third branch and an upstream end of the fifth branch being connected to a downstream end of the third branch, the circuit being configured to be able to make all of the first heat transfer fluid passing through the “electric machines” heat exchanger circulate, in a fourth loop for the first heat transfer fluid, through the external radiator and the second pump, in particular so as to allow passive cooling of the first heat transfer fluid passing through the “electric machines” heat exchanger by cooling in the external radiator;
the circuit for the first heat transfer fluid comprises a second three-way valve connecting the third branch downstream of the “electric machines” heat exchanger, the fourth branch upstream of the “batteries” heat exchanger, and the fifth branch upstream of the external radiator;
the circuit comprises a sixth branch connecting the fifth branch upstream of the external radiator and the fourth branch downstream of the “batteries” heat exchanger, and a seventh branch connecting the first branch upstream of the heating device and the fifth branch downstream of the external radiator;
the circuit for the first heat transfer fluid is configured to allow the first heat transfer fluid to circulate in a fifth loop for the first heat transfer fluid in which all of the fluid passing through the “batteries” heat exchanger passes through the external radiator, in particular by passing through the seventh branch and the sixth branch, in particular so as to allow the passive cooling of the first heat transfer fluid passing through the “batteries” heat exchanger by cooling in the external radiator;
the circuit for the first heat transfer fluid is configured to allow, in parallel with the fifth loop for the first heat transfer fluid, the first heat transfer fluid to circulate in the fourth loop for the first heat transfer fluid in which all of the fluid passing through the “electric machines” heat exchanger passes through the external radiator, the fluid circulating in the fifth branch being split between the seventh branch towards the batteries heat exchanger and the third branch towards the “electric machines” heat exchanger, in particular so as to allow the passive cooling simultaneously of the first heat transfer fluid passing through the “batteries” heat exchanger and of the first heat transfer fluid passing through the “electric machines” heat exchanger by cooling in the external radiator;
the circuit for the first heat transfer fluid comprises a third three-way valve connecting the fourth branch downstream of the “batteries” heat exchanger, the second branch, and the sixth branch, in particular so as to connect or not connect the batteries heat exchanger to the external radiator;
the circuit for the first heat transfer fluid is configured to allow the heat transfer fluid to circulate in the third loop for the first heat transfer fluid in which all of the fluid passing through the “electric machines” heat exchanger passes through the external radiator and in the fourth loop for the first heat transfer fluid in which all of the refrigerant passing through the “batteries” heat exchanger passes through the heating device and the two-fluid heat exchanger;
the circuit for the first heat transfer fluid comprises a fourth valve connecting the fourth branch downstream of the “batteries” heat exchanger, the third valve, and the third branch upstream of the “electric machines” heat exchanger, in particular so as to be able to prevent, using the third and fourth valves, the circulation of the first heat transfer fluid from the third loop for the first heat transfer fluid to the fourth loop for the first heat transfer fluid via the sixth branch and via the third branch;
the circuit for the first heat transfer fluid is configured to allow the fluid circulating through the “batteries” heat exchanger to pass upstream not only into the heating device, the two-fluid heat exchanger, and the first pump, thereby forming the third loop for the first heat transfer fluid, but also into a sixth loop for the first heat transfer fluid by entering the “electric machines” heat exchanger and the second pump, so as to enable in particular a mode of heat recovery by the refrigerant circuit, the heat energy being provided by the “electric machines” heat exchanger, the heating device and/or the “batteries” heat exchanger.

Another aspect of the invention relates to a method for operating a system produced as described above, wherein, in a first mode of heating the internal air flow, all of the first heat transfer fluid passing through the heating device then passes through the two-fluid heat exchanger before returning to the first pump via the second branch, the heating device and the two-fluid heat exchanger being active.

Another aspect of the invention relates to a computer program comprising instructions that cause the thermal conditioning system to operate in the way described above.

### BRIEF DESCRIPTION OF THE FIGURES

Further features and advantages of the aspects of the invention will become apparent from reading the following detailed description, for an understanding of which reference will be made to the appended drawings described succinctly below.

FIG. 1 is a schematic view which shows an example of an air conditioning circuit with which the thermal management system produced according to one aspect of the invention is equipped.

FIG. 2 is a schematic view which shows a circuit for a first heat transfer fluid fitted in the thermal management system produced according to one aspect of the invention and intended to operate in collaboration with the air conditioning circuit of FIG. 1.

FIG. 3 is a view of the circuit for the first heat transfer fluid in FIG. 1 operating in a mode of active heating of an internal air flow and of passive heating of one or more batteries (i.e. the batteries) of the vehicle.

FIG. 4 is a view of the circuit for the first heat transfer fluid in FIG. 1 operating in a mode of active cooling (or active heating) of the batteries and of passive cooling of an electric motor and/or of the power electronics of the vehicle.

FIG. 5 is a view of the circuit for the first heat transfer fluid in FIG. 1 operating in a mode of internal cooling by recovery of heat in the two-fluid heat exchanger 14, the heat being supplied by the electrical heating device 14 and/or the batteries heat exchanger 68 and/or the electric motors heat exchanger 66.

FIG. 6 is a schematic view which shows a circuit for the first heat transfer fluid fitted in the thermal management system produced according to another aspect of the invention and intended to operate in collaboration with the air conditioning circuit of FIG. 1.

FIG. 7 is a view of the circuit for the first heat transfer fluid in FIG. 5 operating in a mode of passive cooling of the batteries, of the electric motor and/or of the power electronics of the vehicle.

FIG. 8 is a view of the circuit for the first heat transfer fluid in FIG. 5 operating in a mode of cooling of the batteries and of passive cooling of the electric motor and/or of the power electronics of the vehicle.

FIG. 9 is a view of the circuit for the first heat transfer fluid in FIG. 5 operating in a mode of active cooling of the batteries, of the electric motor and/or of the power electronics of the vehicle.

### DETAILED DESCRIPTION OF THE INVENTION

In the rest of the description, elements having an identical structure or similar functions will be denoted by the same reference.

In the following description, the expression “a first element upstream of a second element” means that the first element is placed before the second element with respect to the direction of circulation, or travel, of a fluid. Similarly, the expression “a first element downstream of a second element” means that the first element is placed after the second element with respect to the direction of circulation, or travel, of the fluid in question. The direction of circulation is defined by the arrows of the compressor or by the arrows of the pumps, as applicable.

The term “branch” here refers to a portion of a circuit open at its two ends and comprising only elements arranged in series.

Note too that the term “batteries” must not be understood as referring to all of the batteries of the vehicle but as referring to a plurality of batteries.

The term “battery” must be understood as meaning any energy storage entity able to release this energy in electrical form.

In the drawings, the pipes in which the heat transfer fluid is moving will be depicted in bold lines and the pipes in which the heat transfer fluid is not moving will be depicted in thinner lines.

As shown in the various figures, the invention relates to a thermal conditioning system. This is, for example, a thermal management system for a motor vehicle. In this case it is an electric or hybrid motor vehicle which includes an electric motor which provides motive torque to the driven wheels of the vehicle. The electric motor is supplied with electric current at least by batteries, referred to as traction batteries. During the operation of the vehicle, the electric motor and the battery are liable to produce heat.

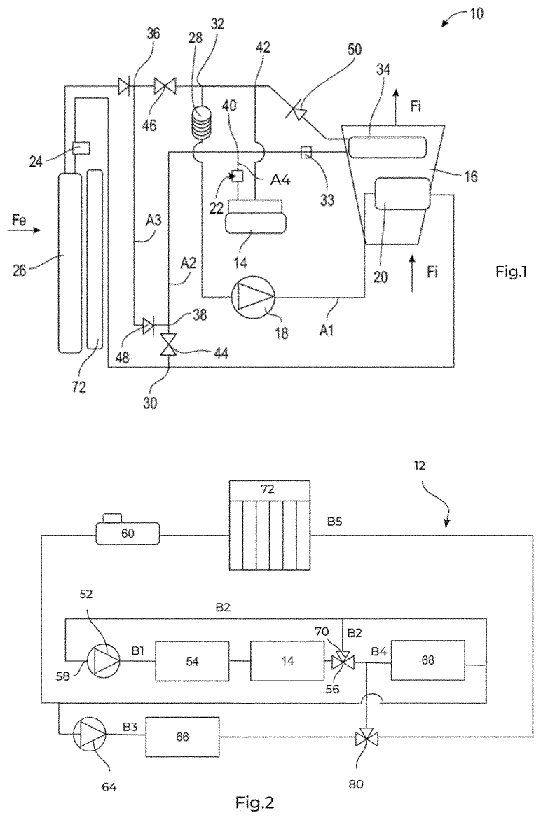

As shown more particularly in FIG. 1, said system comprises a first circuit (or refrigerant circuit) 10 for air conditioning, in which a refrigerant circulates, as shown in FIG. 1, and a second circuit 12 for a first heat transfer fluid, in which a heat transfer fluid circulates, as shown in FIG. 2.

The heat transfer fluid is, for example, a heat transfer liquid such as water comprising an anti-freeze, in particular glycol water, or any other suitable heat transfer fluid. The refrigerant is for example a hydrofluorocarbon, such as R-134a or R1234yf or R744.

The air conditioning circuit 10 includes a two-fluid heat exchanger 14 arranged jointly on the second heat transfer fluid circulation circuit 12. The two-fluid heat exchanger 14 is configured to allow an exchange of heat between the refrigerant, circulating in the air conditioning circuit 10, and the first heat transfer fluid, circulating in the circuit 12 for the first heat transfer fluid, without mixing between the heat transfer fluid and the refrigerant. This type of heat exchanger is commonly referred to by those skilled in the art as a “chiller”, as in the example of FIG. 1.

The air conditioning circuit 10 is configured to allow, in a heat pump mode, heating of an air flow, depicted by an arrow referenced Fi, by means of compression and expansion of the refrigerant.

The air flow Fi is, for example, an internal air flow Fi, intended to be sent into the vehicle interior to heat it. The system thus makes it possible to heat the vehicle interior using heat energy taken from the first heat transfer fluid.

The internal air flow (Fi) circulates, for example, in a heating, ventilation and/or air conditioning (HVAC) device 16 for the vehicle interior.

By way of non-limiting example, the air conditioning circuit 10 shown in FIG. 1 more particularly comprises a main loop A1 for circulation of refrigerant comprising, in the direction of circulation of the refrigerant: the compressor 18, the condenser 20 arranged in the internal air flow Fi, a second expansion device 24, and an evaporator-condenser 26 arranged in an external air flow Fe. The evaporator-condenser 26 is thus generally arranged on the front face of the motor vehicle. A flap (not shown) may also be installed in the heating, ventilation and/or air conditioning device 16 in order to prevent the internal air flow from passing through the condenser 20 or allow it to do so. The main loop A1 for circulation of refrigerant may also comprise an accumulator 28 allowing a phase separation of the refrigerant and arranged upstream of the compressor 18, between the evaporator-condenser 26 and said compressor 18. The condenser 20 makes it possible to transmit heat energy to the internal air flow Fi.

The condenser 20 is in this case arranged in the heating, ventilation and/or air conditioning device 16 to allow the heat exchange between the refrigerant and the internal air flow Fi. The condenser 20 is in particular arranged directly in the internal air flow.

In a variant according to one aspect of the invention that has not been shown, the condenser 20 makes it possible to exchange heat with the internal air flow via a circuit for heat transfer fluid. In this case, the condenser 20 transmits heat energy to this heat transfer fluid, then the heat transfer fluid transmits said heat energy to the internal air flow via a heat exchanger, referred to as a “heater core”, arranged directly in the internal air flow.

The refrigerant is in the high-pressure gaseous state as it leaves the compressor 18. It then undergoes condensation while passing through the condenser 20, thereby giving up heat energy to the internal air flow Fi, and transitions into the liquid state. It then undergoes expansion in the first expansion device 22 and enters the first two-fluid exchanger 14 where it evaporates, absorbing heat energy from the heat transfer fluid.

By recovering heat energy from the second circuit 12 for the first heat transfer fluid, it is possible to heat the internal air flow Fi by means of the condenser 20 even when the outside temperature is too low for the first air conditioning circuit 10 to be able to operate in external heat pump mode by an exchange of heat with the outside air. This makes it possible in particular to avoid having to equip the heating, ventilation and/or air conditioning device 16 with an electrical air heating device.

The air conditioning circuit 10 is in this case reversible. This means that it is also capable of operating in a mode of cooling of the internal air flow Fi.

The air conditioning circuit 10 also has a first bypass branch A2 for the circulation of refrigerant, connected in parallel with the evaporator-condenser 26 of the main loop A1. This first bypass branch A2 connects more particularly:
a first junction point 30 arranged downstream of the condenser 20, on the main loop A1, between said condenser 20 and the second expansion device 24, and
a second junction point 32 arranged downstream of the evaporator-condenser 26 on the main loop A1, between said evaporator-condenser 26 and the compressor 18, more specifically upstream of the accumulator 28.

This first bypass branch A2 includes in particular a third expansion device 33 and an evaporator 34 arranged in the internal air flow Fi.

The air conditioning circuit 10 further includes a second bypass branch A3 connecting the outlet of the evaporator-condenser 26 and the inlet of the third expansion device 33. This third circulation pipe A3 connects more particularly:
a third junction point 36 arranged downstream of the evaporator-condenser 26 on the main loop A1, between said evaporator-condenser 26 and the compressor 18, more specifically upstream of the accumulator 28, and
a fourth junction point 38 arranged on the first bypass branch A2 upstream of the third expansion device 33, between the first junction point 30 and the third expansion device 33.

The air conditioning circuit 10 also includes a third bypass branch A4 connecting the inlet of the third expansion device 33 and the inlet of the compressor 18. This third bypass branch A4 connects specifically:
a fifth junction point 40 arranged on the first bypass branch A2 upstream of the third expansion device 33, between the fourth junction point 38 of the third circulation pipe A3 and said third expansion device 33, and
a sixth junction point 42 arranged upstream of the compressor 18, between the evaporator 34 and the second junction point 32 of the first bypass branch A2, more specifically upstream of the accumulator 28.

The third bypass branch A4 in particular includes the first expansion device 22 and the two-fluid heat exchanger 14. The first expansion device 22 is arranged upstream of the two-fluid heat exchanger 14, between the fifth junction point 40 and said two-fluid heat exchanger 14.

The air conditioning circuit 10 also includes a device for redirecting the refrigerant in order to define the branch through which it circulates. In the example illustrated in FIG. 1, this refrigerant redirection device includes in particular:
a first shut-off valve 44 arranged on the first bypass branch A2 between the first junction point 30 and the fourth junction point 38,
a second shut-off valve 46 arranged on the first refrigerant circulation loop A1 between the third junction point 36 and the second junction point 32,
a non-return valve 48 arranged on the third circulation pipe A3, arranged such that it prevents the circulation of refrigerant from the fourth junction point 38 towards the third junction point 36,
a non-return valve 50 arranged on the first bypass branch A2, arranged such that it prevents the circulation of refrigerant from the sixth junction point 42 towards the evaporator 34.

The first 22, second 24 and third 33 expansion devices include a shut-off function for preventing the refrigerant from passing through them when this function is activated.

It is however entirely possible to envisage other means in order to define the branch through which the refrigerant circulates, such as for example three-way valves arranged strategically on junction points.

When the air conditioning circuit 10 operates in internal heat pump mode (also commonly referred to as “heat recovery” mode by those skilled in the art), the shut-off valves are controlled such that refrigerant circulated in the third bypass branch A4 and does not circulate in the evaporator-condenser 26. The two-fluid heat exchanger 14 then fulfils the function of evaporating the refrigerant, while the refrigerant is not circulating through the evaporator-condenser 26, such that only the heat energy from the heat transfer fluid in the circuit 12 for the first heat transfer fluid is used to heat the internal air flow Fi. In this internal heat pump operating mode, the two-fluid heat exchanger 14 is active with a refrigerant evaporating function.

The circuit 12 for the first heat transfer fluid will now be described with reference to FIG. 2.

The circuit 12 for the first heat transfer fluid comprises a first branch B1 for circulation of the first heat transfer fluid comprising, in the direction of circulation of the heat transfer fluid: a heating device 54 for the heat transfer fluid and said two-fluid heat exchanger 14. The circuit 12 also comprises a circulation pump 52, which is for example upstream of the heating device 54 for the heat transfer fluid.

The heating device 54 for the heat transfer fluid is in this case an electrical heating device, for example which heats the heat transfer fluid for example by means of electrical resistors or any other suitable electrical heating means.

The circuit 12 for the first heat transfer fluid also comprises a second branch B2, an upstream end of which is connected directly to the first branch B1 at a first connection point 56 downstream of the two-fluid heat exchanger 14. A downstream end of the second branch B2 is connected directly to the first branch B1 at a second connection point 58 arranged upstream of the electrical heating device 54, more particularly upstream of the first pump 52 in this example.

Apart from the first pump 52, the heating device 54 for the heat transfer fluid and the two-fluid heat exchanger 14, the first branch B1 does not include any other device capable of substantially modifying the amount of heat accumulated by the heat transfer fluid. The first branch B1 notably does not include any other heat exchanger. More particularly, the two-fluid heat exchanger 14 is arranged directly downstream of the heating device for the heat transfer fluid without any other device being positioned in between.

Likewise, the second branch B2 does not include any device capable of substantially modifying the amount of heat accumulated by the heat transfer fluid. The second branch B2 notably does not include any heat exchanger. It will be noted that the second branch B2 includes, for example, in a variant which is not shown, a device of the expansion vessel type.

The circuit 12 for the first heat transfer fluid is configured such that, in a first mode of heating of the internal air flow Fi, all of the heat transfer fluid passing through the heating device 54 then passes through the two-fluid heat exchanger 14 before returning to the electrical heating device 54 via the second branch B2, thus forming a first loop L1 for circulation of the first heat transfer fluid, which also includes the first 52. It will be noted that the pump 52 may be situated at a different location in the loop L1, for example directly upstream or downstream of the two-fluid heat exchanger 14.

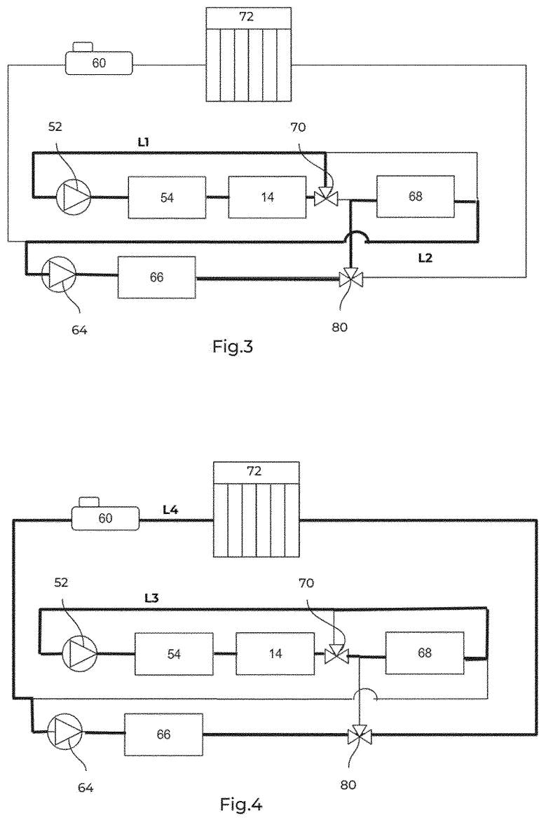

In this first mode of heating of the internal air flow Fi, the heating device 54 is active and the two-fluid heat exchanger 14 is active with a refrigerant evaporating function. This operating mode is shown in particular in FIG. 3, in which the pipes in which the heat transfer fluid circulates are indicated in bold lines, the heat transfer fluid remaining substantially stationary in the pipes which are not indicated in bold lines. The direction of circulation of the heat transfer fluid is indicated by the direction of the triangle in the pump 52.

The air conditioning circuit 10 operates at the same time in internal heat pump mode. Thus, the heating device 54 supplies heat energy to the heat transfer fluid circulated by the first pump 52. A part of this heat energy is transmitted to the refrigerant via the two-fluid heat exchanger 14, in such a way as to then heat the internal air flow Fi via the condenser 20. All of the heat transfer fluid in circulation then returns to the first pump 52 via the second branch B2 so as to be heated again by the heating device 54. Thus, the heat accumulated by the heat transfer fluid increases rapidly with each new cycle in a first loop formed by the first branch B1 and the second branch B2. This makes it possible to rapidly increase the temperature of the internal air flow Fi via the air conditioning circuit 10.

To allow rapid heating, the first loop formed only by the first branch B1 and the second branch B2 is advantageously very short. Advantageously, this loop includes only the first pump 52, the heating device 54 and the two-fluid heat exchanger 14, and optionally the expansion vessel 60, together with means for redirecting the heat transfer fluid only in this first loop L1.

The circuit 12 for the first heat transfer fluid comprises a third branch B3 which comprises a second pump 64 for circulation of the first heat transfer fluid and an “electric machines” heat exchanger, which is configured to allow the exchange of heat between the power electronics and/or an electric motor of the vehicle, for the one part, and the heat transfer fluid, for the other part. In a variant, it is a heat exchanger dedicated to another function in the vehicle. In general, it is a heat exchanger in which the heat transfer fluid circulates.

The term “power electronics” will be understood to mean electronic devices other than the batteries and the electric motor.

In the embodiment shown in the figures, the “electric machines” heat exchanger exchanges heat with the electric motor.

The circuit 12 for the first heat transfer fluid also comprises a fourth branch B4 which has a batteries heat exchanger 68, which is configured to allow the exchange of heat between batteries of the vehicle and the heat transfer fluid. The fourth branch B4 has an upstream end which is connected to a downstream end of the first branch B1 and a downstream end which is connected to the second branch (B2), an upstream end of the fourth branch (B4) also being connected to a downstream end of the third branch (B3), and a downstream end of the fourth branch (B4) being connected to an upstream end of the third branch (B3).

As illustrated in FIG. 3, the circuit 12 for the first heat transfer fluid is configured such that, in a second loop L2 for the first heat transfer fluid, the heat transfer fluid entering the “batteries” heat exchanger 68, for example all of the heat transfer fluid entering the “batteries” heat exchanger 68, passes through the “electric machines” heat exchanger 66 and enters the second pump 64.

The second loop L2 illustrated in FIG. 3 makes it possible to heat the heat transfer liquid passing through the “batteries” heat exchanger 68 using the heat recovered by the “electric machines” heat exchanger 66.

Apart from the second pump 64 and the “electric machines” heat exchanger 66, the third branch B3 does not include any other device capable of substantially modifying the amount of heat accumulated by the heat transfer fluid. The third branch B3 notably does not include any heat exchanger.

As shown in FIG. 4, the circuit 12 for the first heat transfer fluid is configured to be able to make all of the refrigerant passing through the heating device 54 and the two-fluid heat exchanger 14 circulate through the “batteries” heat exchanger 68 in a third loop L3 for the first heat transfer fluid.

The circulation of the first heat transfer fluid in the loop L3 allows for example a mode of cooling of the batteries in which the air conditioning circuit 10 evaporates the refrigerant in the two-fluid heat exchanger 14 to cool the heat transfer fluid circulating in the two-fluid heat exchanger 14. The two-fluid heat exchanger 14 is then active.

The circulation of the first heat transfer fluid in the loop L3 also allows a mode of heating of the batteries of the vehicle when the electrical heating device 54 is active. The two-fluid heat exchanger 14 is then inactive, i.e. the heat transfer fluid can pass through it without a significant exchange of heat with the refrigerant in the air conditioning circuit 10, for example by completely closing the first expansion device 22.

The circulation of the first heat transfer fluid in the loop L3 also allows a second mode of heating of the internal air flow Fi in which the air conditioning circuit 10 operates in internal heat pump mode and in which the heat transfer fluid in the circuit 12 for the first heat transfer fluid is heated in the batteries heat exchanger 68, i.e. a mode of recovery of the heat from the batteries to heat the vehicle interior.

The circuit for the first heat transfer fluid comprises a first three-way valve 70 connecting the first branch B1 downstream of the two-fluid heat exchanger 14, the fourth branch B4 upstream of the “batteries” heat exchanger 68, and the upstream end of the second branch B2. The first three-way valve 70 makes it possible to alternatively select the circulation of the first heat transfer fluid towards the second branch B2 and thus the circulation of the first heat transfer fluid in the second loop B2, or towards the fourth branch B4 and thus the circulation of the first heat transfer fluid in the third loop B3.

As illustrated in FIG. 2, the circuit 12 for the first heat transfer fluid comprises a fifth branch B5 equipped with an expansion vessel 60 and a radiator 72 arranged in an external air flow (Fe). A downstream end of the fifth branch B5 is connected to an upstream end of the third branch B3 and an upstream end of the fifth branch B5 is connected to a downstream end of the third branch B3.

In a variant, the expansion vessel 60 is situated in another branch of the circuit.

As illustrated in FIG. 4, the circuit for the first heat transfer fluid is thus configured to be able to make all of the heat transfer fluid passing though the “electric machines” heat exchanger 66 circulate through the external radiator 72 and the second pump 64 in a fourth loop L4 for the first heat transfer fluid, in particular so as to allow passive cooling of the heat transfer fluid passing through the “electric machines” heat exchanger 66 by cooling in the external radiator 72.

The circulation of the first heat transfer fluid in the fourth loop L4 allows passive cooling of the electric motor by discharging heat from the electric motor into the heat transfer fluid 12 through the electric machines heat exchanger 66, and then discharging heat into the external air flow Fe through the external radiator 72.

The circuit 12 for the first heat transfer fluid comprises a second three-way valve 80 connecting the third branch B3 downstream of the “electric machines” heat exchanger 66, the fourth branch B4 upstream of the “batteries” heat exchanger 68, and the fifth branch B5 upstream of the external radiator 72.

The second three-way valve 80 makes it possible to alternatively select the heat transfer fluid to be sent towards the fourth branch B4 to form the second loop L2 for circulation of the first heat transfer fluid or towards the fifth branch B5 to form the fourth loop L4 for circulation of the first heat transfer fluid.

Furthermore, as illustrated in FIG. 5, the circuit described above simultaneously allows the circulation of the first heat transfer fluid in the second loop L2 for the first heat transfer fluid and in the third loop L3 for circulation of the first heat transfer fluid.

The flow rate in each of the loops L2 and L3 is regulated by the delivery of their respective pump 52, 64.

The common feature of the two loops L2 and L3 is the batteries heat exchanger 68, in which the flow rate of the first heat transfer fluid is the sum of the flow rates of the first heat transfer fluid in each of the two loops L2 and L3.

The circulation of the first heat transfer fluid simultaneously in the loops L2 and L3 allows a third mode of heating of the internal air flow in which the two-fluid heat exchanger is active for the purpose of recovering heat from the batteries and/or from the electric motor 66 and/or from the electrical heating device 54, if the latter is active.

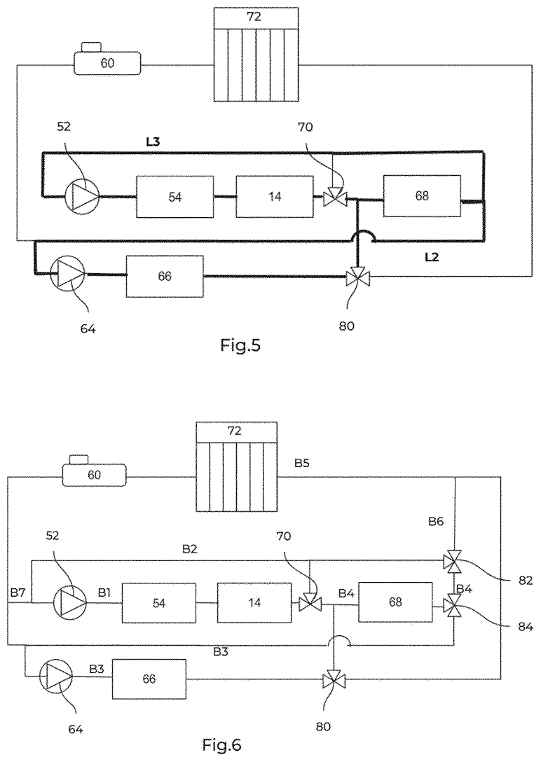

FIG. 6 is a schematic view which shows a circuit for the first heat transfer fluid fitted in the thermal management system produced according to another aspect of the invention and intended to operate in collaboration with the air conditioning circuit of FIG. 1.

The circuit 12 for the first heat transfer fluid comprises a sixth branch B6 connecting the fifth branch B5 upstream of the external radiator 72 and the fourth branch B4 downstream of the “batteries” heat exchanger 68.

The circuit for the first heat transfer fluid comprises a third three-way valve 82 connecting the fourth branch B4 downstream of the “batteries” heat exchanger 68, the second branch B2, and the sixth branch B6, in particular so as to connect or not connect the batteries heat exchanger to the external radiator 72.

The circuit 12 for the first heat transfer fluid also comprises a fourth three-way valve 84 connecting the fourth branch B4 downstream of the “batteries” heat exchanger (68), the third valve (82) and the third branch (B3) upstream of the “electric machines” heat exchanger (66).

The third and fourth valves 82, 84 make it possible in particular to prevent the circulation of the first heat transfer fluid from the third loop L3 for the first heat transfer fluid towards the fourth loop L4 for the first heat transfer fluid by preventing the first heat transfer fluid from passing from one loop L3 to the other L4 via the sixth branch B6 and via the third branch B3.

The circuit 12 for the first heat transfer fluid also comprises a seventh branch B7 connecting the first branch B1 upstream of the heating device 54 and the fifth branch B5 downstream of the external radiator 72.

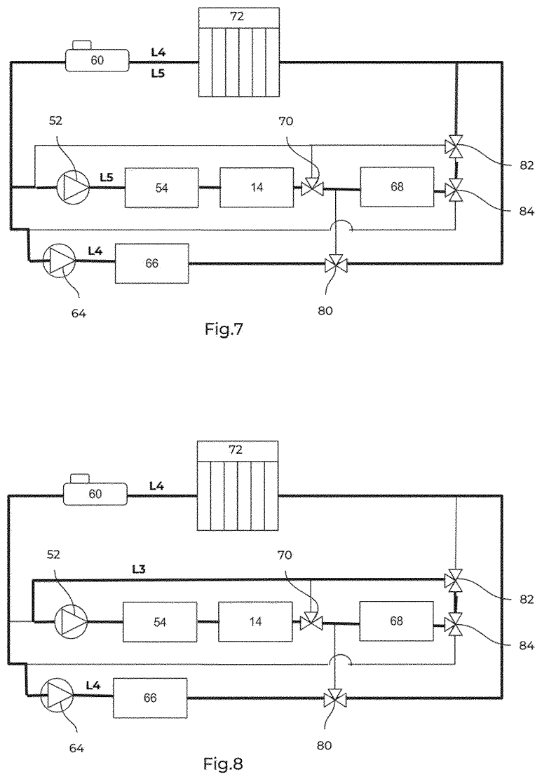

The circuit 12 for the first heat transfer fluid is thus configured, as illustrated in FIG. 7, to allow, in addition to the circulation modes illustrated above which are still possible, the first heat transfer fluid to circulate in a fifth loop L5 for the first heat transfer fluid in which all of the fluid passing through the “batteries” heat exchanger 68 passes through the external radiator 72, in particular by passing through the seventh branch B7 and the sixth branch B6, in particular so as to allow the passive cooling of the first heat transfer fluid passing through the “batteries” heat exchanger 68 by cooling in the external radiator 72. In this configuration, the fourth valve 84 prevents the circulation of the first heat transfer fluid towards the third branch B3 and the third valve 82 prevents the circulation of the first heat transfer fluid towards the second branch B2. Furthermore, the third valve 83 and the third valve 84 connect the sixth branch B6 to the fourth branch B4.

As illustrated in FIG. 7, the circulation in the fifth loop is for example realized jointly with the circulation of the first heat transfer fluid in the fourth loop B4. The flow rate of the first heat transfer fluid in the external radiator then corresponds to the sum of the flow rates in the first pump 52 (or in the batteries heat exchanger 68) and in the second pump 64 (or in the electric machines heat exchanger 66).

It is thus possible to passively cool the batteries and the electric machines (or power electronics).

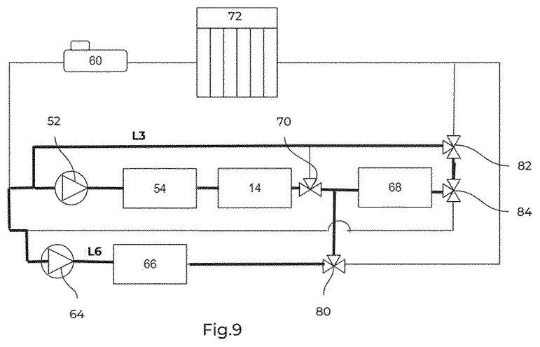

As illustrated in FIG. 8, the circuit 12 for the first heat transfer fluid is configured to allow the first heat transfer fluid to circulate in the third loop L4 for the first heat transfer fluid in which all of the fluid passing through the “electric machines” heat exchanger 66 passes through the external radiator 72 and in the fourth loop L4 for the first heat transfer fluid in which all of the refrigerant passing through the “batteries” heat exchanger 68 passes through the heating device 54 and the two-fluid heat exchanger 14.

In this circulation mode, the third valve 82 and the fourth valve 84 prevent the circulation of the first heat transfer fluid between the third and fourth loops for the first heat transfer fluid L3, L4 by preventing the fluid from passing via the sixth branch B6 towards the external radiator 72 and via the third branch B3.

It will be noted that, although no valve prevents the circulation of the first heat transfer fluid via the seventh branch B7, such a valve is in fact unnecessary because maintaining the flow rate in each loop naturally involves no circulation in the seventh branch B7.

As illustrated in FIG. 9, the circuit 12 for the first heat transfer fluid is configured to allow the fluid circulating through the “batteries” heat exchanger 68 to pass upstream not only into the heating device 54, the two-fluid heat exchanger 14, and the first pump 54, thereby forming the third loop L3 for the first heat transfer fluid, but also into a sixth loop L6 for the first heat transfer fluid by entering the “electric machines” heat exchanger 66 and the second pump 64, so as to enable in particular a mode of heat recovery by the refrigerant circuit, the heat energy being provided by the “electric machines” heat exchanger 66, the electrical heating device 54 and/or the “batteries” heat exchanger (68). This embodiment is similar to the embodiment in FIG. 5, but the embodiment in FIG. 7 makes use of the return of the first heat transfer fluid towards the sixth loop via the second branch B2 and then via the seventh branch B7, and this can minimize the losses of heat in relation to the embodiment in FIG. 5.

1. A thermal management system for a hybrid or electric vehicle, the thermal management system comprising a reversible air conditioning circuit in which a refrigerant circulates and comprising:
a two-fluid heat exchanger arranged jointly on a circuit for a first heat transfer fluid,
wherein the reversible air conditioning circuit comprising the following in succession, in a main loop:
a compressor,
a first heat exchanger arranged to exchange heat energy with a heat transfer fluid directly or indirectly,
an expansion member for the refrigerant and
a second heat exchanger arranged to exchange heat energy with a heat transfer fluid directly or indirectly,
wherein the circuit for the first heat transfer fluid comprising:
a first branch comprising a first pump, a heating device for the first heat transfer fluid, and the two-fluid heat exchanger;
a second branch;
an upstream end of which is connected directly to the first branch downstream of the two-fluid heat exchanger;
a downstream end of which is connected directly to an upstream end of the first branch;
a third branch comprises:
a second pump, and
a third heat exchanger, example-an “electric machines” heat exchanger, which allows the exchange of heat between power electronics and/or an electric motor of the vehicle, for one part, and the first heat transfer fluid, for the other part; and
a fourth branch comprises:
a fourth heat exchanger, “batteries” heat exchanger, which is configured to exchange heat between batteries of the vehicle and the first heat transfer fluid,
an upstream end which is connected to a downstream end of the first branch, and
a downstream end which is connected to the second branch, an upstream end of the fourth branch is connected to a downstream end of the third branch, and a downstream end of the fourth branch is connected to an upstream end of the third branch,
wherein the circuit for the first heat transfer fluid is configured such that, in a first mode of heating the internal air flow:
in a first loop for the first heat transfer fluid, the first heat transfer fluid passing through the heating device, passes through the two-fluid heat exchanger and enters the first pump,
wherein the heating device and the two-fluid heat exchanger are active, so as to heat the refrigerant entering the two-fluid heat exchanger, and
at a same time as or independently of the circulation of the first heat transfer fluid in the first loop for the first heat transfer fluid, the circuit is configured such that, in a second loop for the first heat transfer fluid, the first heat transfer fluid entering the “batteries” heat exchanger passes through a “electric machines” heat exchanger and enters the second pump, so as to heat the first heat transfer fluid passing through the “batteries” heat exchanger using the heat recovered by the “electric machines” heat exchanger.

2. The thermal management system as claimed in claim 1, wherein, in the first branch, the two-fluid heat exchanger is arranged downstream of the heating device for the first heat transfer fluid.

3. The thermal management system as claimed in claim 2, wherein, apart from the first pump, the heating device for the first heat transfer fluid, and the two-fluid heat exchanger, the first branch does not include any other device substantially modifying an amount of heat accumulated by the first heat transfer fluid.

4. The thermal management system as claimed in claim 3, wherein the second branch does not include any device substantially modifying the amount of heat accumulated by the first heat transfer fluid.

5. The thermal management system as claimed in claim 4, wherein the circuit for the first heat transfer fluid is configured to be able to make all of the refrigerant passing through the heating device and the two-fluid heat exchanger circulate through the “batteries” heat exchanger in a third loop for first heat transfer fluid, so as to heat the first heat transfer fluid passing through the “batteries” heat exchanger when the heating device is active or alternatively so as to cool the first heat transfer fluid passing through the “batteries” heat exchanger when the two-fluid heat exchanger is active.

6. The thermal management system as claimed in claim 1, wherein the circuit for the first heat transfer fluid comprises a first three-way valve connecting the first branch downstream of the two-fluid heat exchanger, the fourth branch upstream of the “batteries” heat exchanger, and the upstream end of the second branch.

7. The thermal management system as claimed in claim 1,
wherein the circuit for the first heat transfer fluid further comprises:
a fifth branch provided with a radiator arranged in an external air flow,
a downstream end of the fifth branch is connected to an upstream end of the third branch and an upstream end of the fifth branch is connected to a downstream end of the third branch,
wherein the circuit is configured to be able to make all of the first heat transfer fluid passing through the “electric machines” heat exchanger circulate, in a fourth loop for the first heat transfer fluid, through the external radiator and the second pump, so as to allow passive cooling of the first heat transfer fluid passing through the “electric machines” heat exchanger by cooling in the external radiator.

8. The thermal management system as claimed in claim 7, wherein the circuit for the first heat transfer fluid further comprises a second three-way valve connecting the third branch downstream of the “electric machines” heat exchanger, the fourth branch upstream of the “batteries” heat exchanger, and the fifth branch upstream of the external radiator.

9. The thermal management system as claimed in claim 7, wherein the circuit further comprises:
a sixth branch connecting the fifth branch upstream of the external radiator and the fourth branch downstream of the “batteries” heat exchanger; and
a seventh branch connecting the first branch upstream of the heating device and the fifth branch downstream of the external radiator.

10. The thermal management system as claimed in claim 9 wherein the circuit for the first heat transfer fluid is configured to allow the first heat transfer fluid to circulate in a fifth loop for the first heat transfer fluid in which all of the fluid passing through the “batteries” heat exchanger passes through the external radiator, by passing through the seventh branch and the sixth branch, so as to allow the passive cooling of the first heat transfer fluid passing through the “batteries” heat exchanger by cooling in the external radiator.

11. The thermal management system as claimed in claim 10,
wherein the circuit for the first heat transfer fluid is configured to allow, in parallel with the fifth loop for the first heat transfer fluid, the first heat transfer fluid to circulate in the fourth loop for the first heat transfer fluid in which all of the fluid passing through the “electric machines” heat exchanger passes through the external radiator,
wherein the fluid circulating in the fifth branch is split between the seventh branch towards the batteries heat exchanger and the third branch towards the “electric machines” heat exchanger, so as to allow the passive cooling simultaneously of the first heat transfer fluid passing through the “batteries” heat exchanger and of the first heat transfer fluid passing through the “electric machines” heat exchanger by cooling in the external radiator.

12. The thermal management system as claimed in claim 11,
wherein the circuit for the first heat transfer fluid comprises a third three-way valve connecting the fourth branch downstream of the “batteries” heat exchanger, the second branch, and the sixth branch, so as to connect or not connect the batteries heat exchanger to the external radiator.

13. The thermal management system as claimed in claim 10, wherein the circuit for the first heat transfer fluid is configured to allow the heat transfer fluid to circulate in the third loop for the first heat transfer fluid in which all of the fluid passing through the “electric machines” heat exchanger passes through the external radiator and in the fourth loop for the first heat transfer fluid in which all of the refrigerant passing through the “batteries” heat exchanger passes through the heating device and the two-fluid heat exchanger.

14. The thermal management system as claimed in claim 13, wherein the circuit for the first heat transfer fluid comprises a fourth valve connecting the fourth branch downstream of the “batteries” heat exchanger, a third valve, and the third branch upstream of the “electric machines” heat exchanger, so as to be able to prevent, using the third and fourth valves, the circulation of the first heat transfer fluid from the third loop for the first heat transfer fluid to the fourth loop for the first heat transfer fluid via the sixth branch and via the third branch.

15. The thermal management system as claimed in claim 14,
wherein the circuit for the first heat transfer fluid is configured to allow the fluid circulating through the “batteries” heat exchanger to pass upstream not only into the heating device, the two-fluid heat exchanger, and the first pump, thereby forming the third loop for the first heat transfer fluid, but also into a sixth loop for the first heat transfer fluid by entering the “electric machines” heat exchanger and the second pump, so as to enable a mode of heat recovery by the refrigerant circuit,
wherein the heat energy is provided by the “electric machines” heat exchanger, the heating device and/or the “batteries” heat exchanger.

16. A method for operating the thermal management system produced as claimed in claim 1 the method comprising:
passing, in a first mode of heating the internal air flow, all of the first heat transfer fluid through the heating device then passes
passing all of the first heat transfer fluid through the two-fluid heat exchanger before returning to the first pump via the second branch,
wherein the heating device and the two-fluid heat exchanger are active.

17. A non-transitory computer readable medium comprising a computer program comprising instructions that cause the thermal management system as claimed in claim 1 to execute a method for operating the thermal management system produced as claimed in claim 1, the method comprising:
passing, in a first mode of heating the internal air flow, all of the first heat transfer fluid through the heating device then passes
passing all of the first heat transfer fluid through the two-fluid heat exchanger before returning to the first pump via the second branch,
wherein the heating device and the two-fluid heat exchanger are active.
